(19) United States
(12) Patent Application Publication
(10) Pub. No.: US 2025/0231016 A1
(43) Pub. Date: Jul. 17, 2025

(54) Method and Apparatus for Checking of Road Condition

(71) Applicant: HL MANDO CORPORATION, Pyeongtaek (KR)

(72) Inventor: Chanwool KIM, Pyeongtaek (KR)

(21) Appl. No.: 18/793,800

(22) Filed: Aug. 3, 2024

(30) Foreign Application Priority Data
Jan. 11, 2024 (KR) 10-2024-0004764

(51) Int. Cl. G01B 5/28

(52) U.S. Cl. CPC G01B 5/28

(57) ABSTRACT

The present disclosure relates to a method and apparatus for checking road surface conditions, and includes checking, by an electronic apparatus, first sensing data and second sensing data related to driving of a vehicle; processing, by the electronic apparatus, the first sensing data and the second sensing data; if the first sensing data and the second sensing data all converge to a plurality of conditions, calculating a slope based on the distribution of the first sensing data and the second sensing data; calculating an offset, by the electronic apparatus, based on the calculated slope; and checking, by the electronic apparatus, a road surface condition on which the vehicle is driving using the calculated slope and offset. And it can also be applied to other embodiments.

### CROSS-REFERENCE TO RELATED APPLICATION

This application claims priority to and the benefit of Korean Patent Application No. 10-2024-0004764, filed on Jan. 11, 2024, the disclosure of which is incorporated herein by reference in its entirety.

### TECHNICAL FIELD

The present disclosure relates to a method and apparatus for checking road surface conditions.

### BACKGROUND OF THE INVENTION

As autonomous vehicles begin to spread, technologies are being developed to minimize driver intervention by automatically checking the road surface on which the vehicle is driving and autonomously driving the vehicle according to the road surface condition.

There are several methods for checking the condition of the road surface, and currently, in order to check the condition of the road surface, the sensing data obtained from the sensor inside the vehicle is first analyzed. A method of checking the road surface condition by calculating the maximum frictional force between the tire and the road surface through the correlation between the slip ratio and the normalized traction force between the tire and the road surface confirmed based on the analysis results of the sensing data is commonly applied. However, this method has a problem in that the maximum frictional force between the tire and the road surface is not accurately calculated because the sensing data obtained from the sensor inside the vehicle contains a lot of noise. As a result, the road surface condition is not accurately confirmed, and it is inconvenient for the driver to continuously intervene during autonomous driving.

### SUMMARY OF THE INVENTION

### Technical Problem

Embodiments of the present disclosure to solve these conventional problems are directed to providing a method and apparatus for checking road surface conditions capable of checking road surface conditions more accurately regardless of external conditions by estimating in real time an offset, which is a reference point for determining a road surface that may be changed by a change in tire pressure or a vehicle load.

In addition, embodiments of the present disclosure are directed to providing a method and apparatus for checking road surface conditions capable of more accurately checking road surface conditions by estimating an offset using sensing data when noise included in main component data is less than or equal to a threshold value.

### Technical Solution

A method for checking road surface conditions according to an exemplary embodiment of the present disclosure includes checking, by an electronic apparatus, first sensing data and second sensing data related to driving of a vehicle; processing, by the electronic apparatus, the first sensing data and the second sensing data; if the first sensing data and the second sensing data all converge to a plurality of conditions, calculating a slope based on the distribution of the first sensing data and the second sensing data; calculating an offset, by the electronic apparatus, based on the calculated slope; and checking, by the electronic apparatus, a road surface condition on which the vehicle is driving using the calculated slope and offset.

In addition, the checking the first sensing data and the second sensing data may be a step of identifying wheel speed sensing data of the vehicle as the first sensing data, and identifying wheel torque value or longitudinal acceleration sensing data of the vehicle as the second sensing data.

In addition, the first sensing data may be a change amount of a wheel speed difference value between a left front wheel and a left rear wheel of the vehicle and a wheel speed difference value between a right front wheel and a right rear wheel of the vehicle.

In addition, the checking the first sensing data and the second sensing data may include a step of calculating a moving average value of the first sensing data and the second sensing data to check the correlation between the first sensing data and the second sensing data.

The method may further include, after the checking the first sensing data and the second sensing data, checking, by the electronic apparatus, whether the amounts of the first sensing data and the second sensing data are greater than or equal to a preset threshold value.

In addition, the processing the first sensing data and the second sensing data may include calculating a centering (zero-mean) value for each of the first sensing data and the second sensing data, and applying the calculated centering value to a covariance matrix to perform eigenvalue decomposition.

In addition, the processing the first sensing data and the second sensing data may include calculating a first eigenvector and a first eigenvalue for the first sensing data and a second eigenvector and a second eigenvalue for the second sensing data based on the distribution of the first sensing data and the second sensing data through the eigenvalue decomposition.

In addition, the calculating a slope based on the distribution may be a step of if a delta value of a value obtained by dividing a smaller value among the first eigenvalue and the second eigenvalue by a larger value is smaller than a first threshold value, confirming that it converges to the condition, and calculating the slope using an eigenvector related to an eigenvalue having the larger value.

In addition, the calculating a slope based on the distribution may be a step of if a value obtained by dividing a smaller value among the first eigenvalue and the second eigenvalue by a larger value is smaller than a second threshold value, confirming that it converges to the condition and calculating the slope using an eigenvector related to an eigenvalue having the larger value.

In addition, the calculating a slope based on the distribution may be a step of if a covariance value of the first sensing data and the second sensing data is larger than a third threshold value, confirming that it converges to the condition and calculating the slope using an eigenvector related to an eigenvalue having the larger value.

In addition, the calculating an offset may be a step of calculating, as an offset, a point where an average value of the first sensing data and an average value of the second sensing data included in an eigenvector related to a larger eigenvalue among the first eigenvalue and the second eigenvalue intersect.

An apparatus for checking road surface conditions according to an exemplary embodiment of the present disclosure includes a sensor device configured to acquire sensing data when driving a vehicle; and a controller configured to: process a first sensing data and a second sensing data identified in the sensing data, and if both the first sensing data and the second sensing data converge to a plurality of conditions, check a road surface condition in which the vehicle is driving by calculating a slope and offset based on the distribution of the first sensing data and the second sensing data.

In addition, the controller may be configured to identify wheel speed sensing data of the vehicle as the first sensing data, and identify wheel torque value or longitudinal acceleration sensing data of the vehicle as the second sensing data.

In addition, the first sensing data may be a change amount of a wheel speed difference value between a left front wheel and a left rear wheel of the vehicle and a wheel speed difference value between a right front wheel and a right rear wheel of the vehicle.

In addition, the controller may be configured to calculate a moving average value of the first sensing data and the second sensing data to check the correlation between the first sensing data and the second sensing data.

In addition, the controller may be configured to check whether the amounts of the first sensing data and the second sensing data are greater than or equal to a preset threshold value.

In addition, the controller may be configured to calculate a centering (zero-mean) value for each of the first sensing data and the second sensing data and apply the calculated centering value to a covariance matrix to perform eigenvalue decomposition to process the first sensing data and the second sensing data.

In addition, the controller may be configured to calculate a first eigenvector and a first eigenvalue for the first sensing data and a second eigenvector and a second eigenvalue for the second sensing data based on the distribution of the first sensing data and the second sensing data through the eigenvalue decomposition.

In addition, the plurality of conditions may include a condition for checking whether a delta value of a value obtained by dividing a smaller value among the first eigenvalue and the second eigenvalue by a larger value is smaller than a first threshold value, a condition for checking whether a value obtained by dividing a smaller value among the first eigenvalue and the second eigenvalue by a larger value is smaller than a second threshold value, and a condition for checking whether a covariance value of the first sensing data and the second sensing data is greater than a third threshold value.

In addition, the controller may be configured to calculate, as an offset, a point where an average value of the first sensing data and an average value of the second sensing data included in an eigenvector related to a larger eigenvalue among the first eigenvalue and the second eigenvalue intersect.

### Advantageous Effects

As described above, the method and apparatus for checking road surface conditions according to the present disclosure can more accurately check road surface conditions regardless of external conditions by estimating in real time an offset, which is a reference point for determining a road surface that may be changed by a change in tire pressure or a vehicle load.

In addition, the method and apparatus for checking road surface conditions according to the present disclosure can more accurately check road surface conditions by estimating an offset using sensing data when noise included in main component data is less than or equal to a threshold value.

### BRIEF DESCRIPTION OF THE DRAWINGS

FIG. 1 is a diagram illustrating the main configuration of an electronic apparatus for checking a road surface condition according to an exemplary embodiment of the present disclosure.

FIG. 2 is a flowchart illustrating a method of checking a road surface condition according to an exemplary embodiment of the present disclosure.

FIG. 3 is a detailed flowchart illustrating a method of calculating a slope for checking a road surface condition according to an exemplary embodiment of the present disclosure.

FIG. 4 is an exemplary screen diagram illustrating distribution of sensing data according to an exemplary embodiment of the present disclosure.

### DETAILED DESCRIPTION OF THE EMBODIMENTS

Hereinafter, preferred embodiments according to the present disclosure will be described in detail with reference to the accompanying drawings. The detailed description to be disclosed hereinafter with the accompanying drawings is intended to describe exemplary embodiments of the present disclosure and is not intended to represent the only embodiments in which the present disclosure may be implemented. In the drawings, parts unrelated to the description may be omitted for clarity of description of the present disclosure, and like reference numerals may designate like elements throughout the specification.

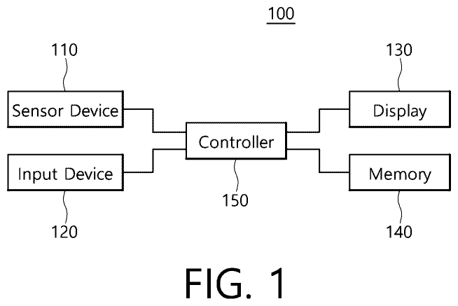

FIG. 1 is a diagram illustrating the main configuration of an electronic apparatus for checking a road surface condition according to an exemplary embodiment of the present disclosure.

Referring to FIG. 1, the electronic apparatus 100 according to the present disclosure may include a sensor device 110, an input device 120, a display 130, a memory 140, and a controller 150.

The sensor device 110 is a sensor for acquiring sensing data about a driving vehicle, and in an embodiment of the present disclosure, it may include a wheel speed sensor and a wheel torque sensor. In addition, in the present disclosure, it may include a longitudinal acceleration sensor instead of a wheel torque sensor. The sensor device 110 may provide the acquired sensing data to the controller 150. To this end, the sensor device 110 may perform CAN (controller area network) communication or serial communication such as RS-232 or the like with the controller 150.

The input device 120 generates input data in response to an input from a user driving a vehicle. To this end, the input device 120 may include a key pad, a dome switch, a touch panel, a touch key, a button, and the like.

The display 130 displays display data related to an operation performed in the electronic apparatus 100. The display 130 includes a liquid crystal display (LCD), a light emitting diode (LED) display, an organic light emitting diode (OLED) display, a micro electro mechanical systems (MEMS) display, and an electronic paper display. The display 130 may be combined with the input device 120 to be implemented as a touch screen capable of input.

The memory 140 stores an operation program for operation of the electronic apparatus 100. In particular, the memory 140 may store various algorithms such as a secondary filter for performing preprocessing on sensing data, an algorithm for calculating a moving average value for sensing data, and an algorithm for processing sensing data.

When the start of driving of the vehicle is confirmed, the controller 150 receives sensing data obtained from the sensor device 110. In this case, the sensing data is sensing data that is the main component for checking the road surface, and may include sensing data related to wheel speed acquired by the wheel speed sensor and sensing data related to wheel torque acquired by the wheel torque sensor. In addition, instead of the sensing data related to the wheel torque, sensing data related to the acceleration obtained by the longitudinal acceleration sensor may be received. In this case, the present disclosure may operate by applying sensing data related to wheel speed and sensing data related to acceleration.

The controller 150 checks the difference value of the wheel speed. More specifically, the controller 150 calculates a difference value dR1 between wheel speeds of the left front wheel and the left rear wheel of the vehicle and a difference value dR2 between wheel speeds of the right front wheel and the right rear wheel. The controller 150 calculates a wheel torque value based on sensing data related to the wheel torque.

The controller 150 performs preprocessing on each sensing data. More specifically, the controller 150 removes noise by applying dR1 and dR2 to the secondary filter, and applies the calculated wheel torque value to the secondary filter to remove noise.

The controller 150 generates a delta value, which is a change amount of dR1 and dR2 from which noise is removed, as first sensing data, and generates a wheel torque value from which noise is removed as second sensing data. And the controller 150 may calculate a moving average value for each of the first sensing data and the second sensing data.

The controller 150 checks the correlation between the first sensing data and the second sensing data based on the moving average value. For example, the correlation may be either a positive correlation in which the first sensing data and the second sensing data increase or decrease together, or a negative correlation in which the first sensing data and the second sensing data tend to be opposite.

When it is confirmed that the first sensing data and the second sensing data have a correlation, the controller 150 checks whether the amounts of the first sensing data and the second sensing data are each greater than or equal to a threshold value. For example, since the controller 150 must use the same amount of first sensing data and second sensing data, it checks whether the amount of each sensing data is greater than or equal to a specific size preset in the buffer (not shown).

The controller 150 may continuously secure the sensing data until the amount of the sensing data is equal to or greater than the size of the preset buffer. The controller 150 processes the first sensing data and the second sensing data. More specifically, the controller 150 performs centering (zero-mean) of the first sensing data and the second sensing data. The controller 150 applies a value derived according to the centering performance result to the covariance matrix, and the controller 150 performs eigenvalue decomposition using the covariance matrix. Through this, the controller 150 may derive a first eigenvector (\vec{e}₁) and a first eigenvalue (λ₁) for the first sensing data, and a second eigenvector (\vec{e}₂) and a second eigenvalue (λ₂) for the second sensing data. In this case, in the embodiment of the present disclosure, for convenience of explanation, it will be described that the first eigenvalue (λ₁) has a value greater than the second eigenvalue (λ₂) as an example.

The controller 150 checks whether a value related to the sensing data converges to a plurality of conditions. More specifically, the controller 150 may confirm that if the delta value (Δλ₂/λ1) of the value obtained by dividing the second eigenvalue (λ₂) by the first eigenvalue (λ₁) is less than the first threshold value, it converges to the first condition. The controller 150 may confirm that if the value obtained by dividing the second eigenvalue (λ₂) by the first eigenvalue (λ₁) is less than the second threshold value, it converges to the second condition. In addition, the controller 150 may confirm that if the covariance value of the first sensing data and the second sensing data is greater than the third threshold value, it converges to the third condition.

In this case, the first to third threshold values may be values that serve as a reference for preventing a case where unnecessary sensing data is large due to excessive noise included in the sensing data when checking the road surface condition. Through this, it is possible to improve the accuracy of checking the road surface condition by excluding the case of checking the road surface condition using sensing data containing excessive noise.

If the value related to the sensing data converges to a plurality of conditions, the controller 150 may calculate a slop with respect to the main component, for example, a wheel speed and a wheel torque using a first eigenvector (\vec{e}₁) related to a first eigenvalue (λ₁) having a larger eigenvalue among the first eigenvector (\vec{e}₁) and the second eigenvector (\vec{e}₂).

The controller 150 may calculate, as an offset, a value at a location where an average value of the first sensing data and an average value of the second sensing data included in the first eigenvector (\vec{e}₁) related to the first eigenvalue (λ₁) intersect. As described above, the present disclosure may more accurately estimate the slope by calculating an offset affected by the load of the vehicle, the change in the air pressure of the tire, and the like, thereby improving the accuracy of checking the road surface condition.

Conversely, if the value related to the sensing data do not converge to a plurality of conditions, the controller 150 may determine that the distribution of the sensing data is large, that is, determine that the sensing data contains excessive noise and so again collect the sensing data from the sensor device 110.

The controller 150 may set the calculated offset as a reference point, and generate a graph having a slope calculated based on the offset to check the road surface condition.

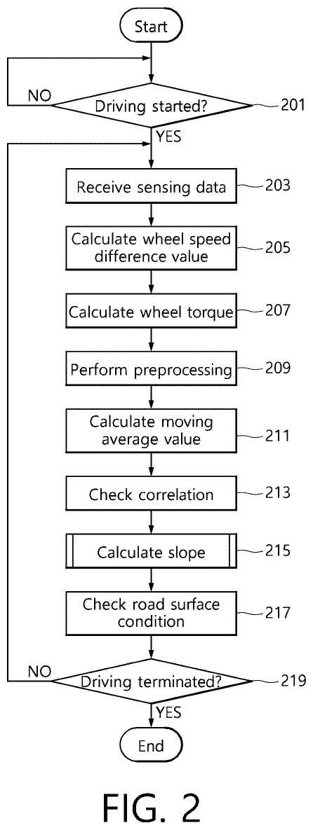

FIG. 2 is a flowchart illustrating a method of checking a road surface condition according to an exemplary embodiment of the present disclosure.

Referring to FIG. 2, in step 201, when the start of driving of the vehicle is confirmed, the controller 150 performs step 203, and when the start of driving of the vehicle is not confirmed, the controller 150 waits for the start of driving of the vehicle.

In step 203, the controller 150 receives sensing data obtained from the sensor device 110. In this case, the sensing data is sensing data that is the main component for checking the road surface, and may include sensing data related to wheel speed acquired by the wheel speed sensor and sensing data related to wheel torque acquired by the wheel torque sensor. In addition, instead of the sensing data related to the wheel torque, sensing data related to the acceleration obtained by the longitudinal acceleration sensor may be received. In this case, the present disclosure may operate by applying sensing data related to wheel speed and sensing data related to acceleration.

In step 205, the controller 150 checks the difference value of the wheel speed. More specifically, the controller 150 calculates a difference value dR1 between wheel speeds of the left front wheel and the left rear wheel of the vehicle and a difference value dR2 between wheel speeds of the right front wheel and the right rear wheel. In step 207, the controller 150 calculates a wheel torque value based on sensing data related to the wheel torque.

In step 209, the controller 150 performs preprocessing on each sensing data. More specifically, the controller 150 removes noise by applying dR1 and dR2 to the secondary filter, and applies the calculated wheel torque value to the secondary filter to remove noise.

In step 211, the controller 150 generates a delta value, which is a change amount of dR1 and dR2 from which noise is removed, as first sensing data, and generates a wheel torque value from which noise is removed as second sensing data. And the controller 150 may calculate a moving average value for each of the first sensing data and the second sensing data.

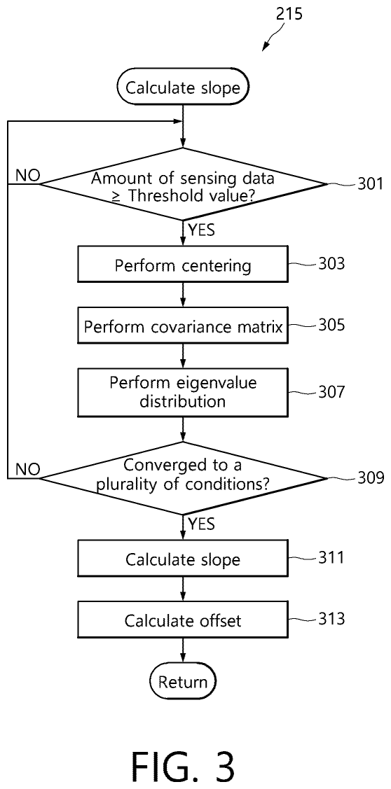

In step 213, the controller 150 checks the correlation between the first sensing data and the second sensing data based on the moving average value, and performs in step 215, and in step 215, the controller 150 calculates a slope. In this case, the method of calculating a slop will be described in more detail with reference to FIG. 3 below. FIG. 3 is a detailed flowchart illustrating a method of calculating a slope for checking a road surface condition according to an exemplary embodiment of the present disclosure.

Referring to FIG. 3, in step 301, the controller 150 checks whether the amounts of the first sensing data and the second sensing data are each equal to or greater than a threshold value. For example, since the controller 150 must use the same amount of first sensing data and second sensing data, it checks whether the amount of each sensing data is greater than or equal to a specific size preset in the buffer (not shown).

As a result of checking in step 301, if the amount of sensing data is greater than or equal to the size of the preset buffer, the controller 150 may perform step 303, and if the amount of sensing data is less than the size of the preset buffer, the controller may additionally secure sensing data.

In steps 303 to 307, the controller 150 processes the first sensing data and the second sensing data. More specifically, in step 303, the controller 150 performs centering (zero-mean) of the first sensing data and the second sensing data. In this case, the mathematical equation for performing centering is shown in Mathematical Equations 1 and 2 below.

$$\overline{X} = X - mean ( X ) \qquad [ Mathematical Equation 1 ]$$

$$\overline{Y} = Y - mean ( Y ) \qquad [ Mathematical Equation 2 ]$$

In this case, the X value may be the first sensing data, and the Y value may be the second sensing data.

In step 305, the controller 150 applies a value derived according to the centering performance result to the covariance matrix, and in step 307, the controller 150 performs eigenvalue decomposition using the covariance matrix. Through this, the controller 150 may derive a first eigenvector (\vec{e}₁) and a first eigenvalue (λ₁) for the first sensing data, and a second eigenvector \vec{e}₍₂₎ and a second eigenvalue (λ₂) for the second sensing data. In this case, in the embodiment of the present disclosure, for convenience of explanation, it will be described that the first eigenvalue (λ₁) has a value greater than the second eigenvalue (λ₂) as an example.

In step 309, the controller 150 checks whether a value related to the sensing data converges to a plurality of conditions. More specifically, the controller 150 may confirm that if the delta value

$$( Δ \frac{{λ}_{2}}{λ \text{?}} )$$

$$\text{?} \text{indicates text missing or illegible when filed}$$

of the value obtained by dividing the second eigenvalue (λ₂) by the first eigenvalue (λ₁) is less than the first threshold value, it converges to the first condition. The controller 150 may confirm that if the value obtained by dividing the second eigenvalue (λ₂) by the first eigenvalue (λ₁) is less than the second threshold value, it converges to the second condition. In addition, the controller 150 may confirm that if the covariance value of the first sensing data and the second sensing data is greater than the third threshold value, it converges to the third condition.

In this case, the first to third threshold values may be values that serve as a reference for preventing a case where unnecessary sensing data is large due to excessive noise included in the sensing data when checking the road surface condition. Through this, it is possible to improve the accuracy of checking the road surface condition by excluding the case of checking the road surface condition using sensing data containing excessive noise.

In step 309, if the value related to the sensing data converges to a plurality of conditions, the controller 150 performs step 311. In step 309, if the value related to the sensing data do not converge to a plurality of conditions, the controller 150 determines that the distribution of the sensing data is large, that is, determines that the sensing data contains excessive noise and returns to step 301. In step 311, the controller 150 may calculate a slop with respect to the main component, for example, a wheel speed and a wheel torque using a first eigenvector (\vec{e}₁) related to a first eigenvalue (λ₁) having a larger eigenvalue among the first eigenvector (\vec{e}₁) and the second eigenvector (\vec{e}₂).

In step 313, the controller 150 may calculate, as an offset, a value at a location where an average value of the first sensing data and an average value of the second sensing data included in the first eigenvector (\vec{e}₁) related to the first eigenvalue (λ₁) intersect. As described above, the present disclosure may more accurately estimate the slope by calculating an offset affected by the load of the vehicle, the change in the air pressure of the tire, and the like, thereby improving the accuracy of checking the road surface condition.

Subsequently, the controller 150 returns to step 217 of FIG. 2, sets the offset as a reference point, and may generate a graph having a slope calculated in step 311 based on the offset to check the road surface condition. In step 219, if the end of the traveling of the vehicle is confirmed, the controller 150 may terminate the corresponding process, and if the end of the traveling is not confirmed, the controller 150 may return to step 203 to perform steps 203 to 217 again. Through this, the electronic apparatus 100 may check the road state in which the vehicle is driving in real time.

In addition, in an embodiment of the present disclosure, it is described as an example that the process is repeatedly performed until the driving of the vehicle is terminated even after the offset is calculated, but the process is not necessarily limited thereto, and the process may be performed only once for the first time to calculate the offset.

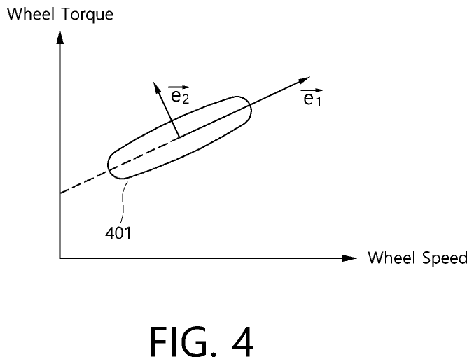

FIG. 4 is an exemplary screen diagram illustrating distribution of sensing data according to an exemplary embodiment of the present disclosure.

Referring to FIG. 4, the first sensing data may be distributed based on the x-axis, and the second sensing data may be distributed based on the y-axis. In this case, the first eigenvector (\vec{e}₁) may mean an eigenvector for the first sensing data, and the second eigenvector (\vec{e}₂) may mean an eigenvector for the second sensing data.

The controller 150 may virtually connect the first eigenvector (\vec{e}₁) to any point on the y-axis, and extract values corresponding to the first sensing data and the second sensing data included in the first eigenvector (\vec{e}₁) virtually connected from the distribution area 401 to the y-axis. The control unit 150 may calculate an average value of the extracted first sensing data and an average value of the second sensing data, respectively, and calculate a value of a location where the average values intersect as an offset reflecting the load of the vehicle and the air pressure of the tire.

The embodiments of the present disclosure disclosed in the present specification and drawings are only provided as specific examples to easily describe the technical content of the present disclosure and to aid understanding of the present disclosure, and are not intended to limit the scope of the present disclosure. Therefore, the scope of the present disclosure should be construed that all changes or modifications derived based on the technical idea of the present disclosure in addition to the embodiments disclosed herein are included in the scope of the present disclosure.

What is claimed is:

1. A method for checking road surface conditions, comprising:
checking, by an electronic apparatus, first sensing data and second sensing data related to driving of a vehicle;
processing, by the electronic apparatus, the first sensing data and the second sensing data;
calculating a slope, by the electronic apparatus, based on the distribution of the first sensing data and the second sensing data if the first sensing data and the second sensing data all converge to a plurality of conditions, calculating a slope;
calculating an offset, by the electronic apparatus, based on the calculated slope; and
checking, by the electronic apparatus, a road surface condition on which the vehicle is driving using the calculated slope and offset.

2. The method for checking road surface conditions of claim 1,
wherein the checking the first sensing data and the second sensing data is a step of:
identifying wheel speed sensing data of the vehicle as the first sensing data, and identifying wheel torque value or longitudinal acceleration sensing data of the vehicle as the second sensing data.

3. The method for checking road surface conditions of claim 2, wherein the first sensing data is a change amount of a wheel speed difference value between a left front wheel and a left rear wheel of the vehicle and a wheel speed difference value between a right front wheel and a right rear wheel of the vehicle.

4. The method for checking road surface conditions of claim 3, wherein the checking the first sensing data and the second sensing data comprises a step of calculating a moving average value of the first sensing data and the second sensing data to check the correlation between the first sensing data and the second sensing data.

5. The method for checking road surface conditions of claim 4,
after the checking the first sensing data and the second sensing data,
further comprising: checking, by the electronic apparatus, whether the amounts of the first sensing data and the second sensing data are greater than or equal to a preset threshold value.

6. The method for checking road surface conditions of claim 5,
wherein the processing the first sensing data and the second sensing data comprises:
calculating a centering (zero-mean) value for each of the first sensing data and the second sensing data, and applying the calculated centering value to a covariance matrix to perform eigenvalue decomposition.

7. The method for checking road surface conditions of claim 6,
wherein the processing the first sensing data and the second sensing data comprises:
calculating a first eigenvector and a first eigenvalue for the first sensing data and a second eigenvector and a second eigenvalue for the second sensing data based on the distribution of the first sensing data and the second sensing data through the eigenvalue decomposition.

8. The method for checking road surface conditions of claim 7,
wherein the calculating a slope based on the distribution is a step of:
if a delta value of a value obtained by dividing a smaller value among the first eigenvalue and the second eigenvalue by a larger value is smaller than a first threshold value, confirming that it converges to the condition, and calculating the slope using an eigenvector related to an eigenvalue having the larger value.

9. The method for checking road surface conditions of claim 8,
wherein the calculating a slope based on the distribution is a step of:
if a value obtained by dividing a smaller value among the first eigenvalue and the second eigenvalue by a larger value is smaller than a second threshold value, confirming that it converges to the condition and calculating the slope using an eigenvector related to an eigenvalue having the larger value.

10. The method for checking road surface conditions of claim 9,
wherein the calculating a slope based on the distribution is a step of:
if a covariance value of the first sensing data and the second sensing data is larger than a third threshold value, confirming that it converges to the condition and calculating the slope using an eigenvector related to an eigenvalue having the larger value.

11. The method for checking road surface conditions of claim 10,
wherein the calculating an offset is a step of:
calculating, as an offset, a point where an average value of the first sensing data and an average value of the second sensing data included in an eigenvector related to a larger eigenvalue among the first eigenvalue and the second eigenvalue intersect.

12. An apparatus for checking road surface conditions, comprising:
a sensor device configured to acquire sensing data when driving a vehicle; and
a controller configured to:
process a first sensing data and a second sensing data identified in the sensing data, and
if both the first sensing data and the second sensing data converge to a plurality of conditions,
check a road surface condition in which the vehicle is driving by calculating a slope and offset based on the distribution of the first sensing data and the second sensing data.

13. The apparatus for checking road surface conditions of claim 12,
wherein the controller is configured to:
identify wheel speed sensing data of the vehicle as the first sensing data, and identify wheel torque value or longitudinal acceleration sensing data of the vehicle as the second sensing data.

14. The apparatus for checking road surface conditions of claim 13, wherein the first sensing data is a change amount of a wheel speed difference value between a left front wheel and a left rear wheel of the vehicle and a wheel speed difference value between a right front wheel and a right rear wheel of the vehicle.

15. The apparatus for checking road surface conditions of claim 14,
wherein the controller is configured to:
calculate a moving average value of the first sensing data and the second sensing data to check the correlation between the first sensing data and the second sensing data.

16. The apparatus for checking road surface conditions of claim 15,
wherein the controller is configured to:
check whether the amounts of the first sensing data and the second sensing data are greater than or equal to a preset threshold value.

17. The apparatus for checking road surface conditions of claim 16,
wherein the controller is configured to:
calculate a centering (zero-mean) value for each of the first sensing data and the second sensing data and apply the calculated centering value to a covariance matrix to perform eigenvalue decomposition to process the first sensing data and the second sensing data.

18. The apparatus for checking road surface conditions of claim 17,
wherein the controller is configured to:
calculate a first eigenvector and a first eigenvalue for the first sensing data and a second eigenvector and a second eigenvalue for the second sensing data based on the distribution of the first sensing data and the second sensing data through the eigenvalue decomposition.

19. The apparatus for checking road surface conditions of claim 18,
wherein the plurality of conditions comprises:
a condition for checking whether a delta value of a value obtained by dividing a smaller value among the first eigenvalue and the second eigenvalue by a larger value is smaller than a first threshold value, a condition for checking whether a value obtained by dividing a smaller value among the first eigenvalue and the second eigenvalue by a larger value is smaller than a second threshold value, and a condition for checking whether a covariance value of the first sensing data and the second sensing data is greater than a third threshold value.

20. The apparatus for checking road surface conditions of claim 19,
wherein the controller is configured to:
calculate, as an offset, a point where an average value of the first sensing data and an average value of the second sensing data included in an eigenvector related to a larger eigenvalue among the first eigenvalue and the second eigenvalue intersect.
